(19) United States
(12) Patent Application Publication
(10) Pub. No.: US 2007/0286514 A1
(43) Pub. Date: Dec. 13, 2007

(54) Minimizing image blur in an image projected onto a display surface by a projector

(76) Inventors: Michael Scott Brown, Singapore (SG); Tat Jen Cham, Singapore (SG); Peng Song, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/450,796

(22) Filed: Jun. 8, 2006

(51) Int. Cl. G06K 9/40

(52) U.S. Cl. 382/254

(57) ABSTRACT

A method for minimizing image blur in an image projected onto a display surface by a projector, the image blur being caused by out-of-focus regions, the method comprising: estimating (10) a spatially varying point-spread-functions (PSF) profile for a test image projected by the projector; and pre-conditioning (11) the image using a predetermined pre-processing algorithm based on the estimated PSF profile; wherein the pre-conditioned image is projected (17) by the projector to minimise image blur.

### TECHNICAL FIELD

The invention concerns a method and system for minimizing image blur when projecting an image onto a display surface using a projector.

### BACKGROUND OF THE INVENTION

Research focusing on projector-based displays has greatly increased the potential of light projectors as display devices. This is in part due to computer vision algorithms that are coupled with projectors and cameras in the same environment. These are referred to as projector-camera systems which facilitate an array of applications, from the calibration of multi-projector display environments, to techniques for user interaction, to algorithms for shadow correction and light suppression and even techniques for displaying on textured surfaces.

While significant advances in projector hardware have been achieved, on the whole, commodity projector hardware has not evolved to accommodate the flexibility allowed by projector-camera systems. Commodity light projectors are still designed to be used in an orthogonal (on-axis) manner with a planar display surface. While vision-based algorithms loosen these constraints and allow for more arbitrary positioning, one consequence is that of focus. Projectors' depth-of-field are often limited, and even slight off-axis projection can lead to blurred regions in the imagery. Currently, such blurred regions are simply ignored in lieu of benefits obtained from flexible projector placement. Techniques to help reduce blur from focus is desirable.

Research on camera-based algorithms for projector display and tiled display systems are divided into two categories: geometric calibration and photometric calibration.

Geometric calibration algorithms use at least one camera to observe projected imagery to compute geometric transforms to rectify the imagery. These techniques can be used for problems as simple as key-stone correction, to calibration of multiple projectors over irregular surfaces. A number of papers have addressed geometric calibration for various setups and configurations. Geometric correction can also be considered a pre-conditioning of the projected imagery, often referred to as pre-warping. In these approaches, the input image is warped before projection to compensate for projector positioning as well as the display surface geometry. The pre-warped image will appear geometrically correct when observed by a viewer. While pre-processing is applied to the displayed imagery it is only in the form of spatial transforms, the original image content is not modified.

Photometric algorithms use cameras to measure various photometric responses of the projectors. These approaches strive to create uniform (or perceptually uniform) imagery across a projector, or more often, across several overlapping projectors. These techniques are typically applied in tandem with geometric correction algorithms. Several papers have addressed this issue in various ways. Photometric correction can also be considered a pre-conditioning of the imagery. These techniques involve pixel-wise transforms to match colors or luminance values across the projectors and do not consider intensity spread due to blurring in the correction process. In the context of image compositing, the issue of limited depth-of-field has been addressed. The projector-based problem is quite different: traditional approaches operate on the image after blurring; the nature of our problem requires that we process the image before the blurring occurs.

### SUMMARY OF THE INVENTION

In a first preferred aspect, there is provided a method for minimizing image blur in an image projected onto a display surface by a projector, the image blur being caused by out-of-focus regions, the method comprising:

estimating a spatially varying point-spread-functions (PSF) profile for a test image projected by the projector; and

pre-conditioning the image using a predetermined pre-processing algorithm based on the estimated PSF profile;

wherein the pre-conditioned image is projected by the projector to minimise image blur.

The PSF may be modeled as a two dimensional circular Gaussian of the form:

$${h}_{σ} = \frac{1}{2 {πσ}^{2}} {e}^{- \frac{{x}^{2} + {y}^{2}}{2 {σ}^{2}}} .$$

The predetermined pre-processing algorithm may be based on Wiener filtering if the image is projected orthogonally to the display surface and the PSF is known or estimated.

The step of estimating a spatially varying PSF profile may comprise estimating the PSF for each pixel of the projector.

The step of estimating a spatially varying PSF profile may comprise:
partitioning the projected image into a plurality of smaller regions; and
computing the PSF for each smaller region.

The method may further comprise compositing a series of global PSF corrections using the PSF computed for each smaller region.

The test image may comprise a plurality of equally sized feature markers in an off-axis manner onto a substantially planar surface.

The method may further comprise:
capturing an image of the projected test image using an image capture device; and
computing a 3×3 homography between the image capture device and the projected test image to rectify the captured image to the test image.

The method may further comprise computing the PSF by comparing the test image with the captured image.

The method may further comprise:
normalizing the intensity of the feature markers by locating a feature marker that is the brightest; and
transforming the other feature markers to have the same DC component as the brightest feature marker.

The method may further comprise:
locating a feature marker having the highest sharpness response by computing a sharpness response in a block-wise fashion about each feature marker,
wherein the sharpest feature is an exemplar feature for determining the PSF of the other feature markers.

The method may further comprise:
computing a set of blurred templates as templates for estimating the PSF of the image using the exemplar feature;
applying cross correlation for each feature marker against all the blurred templates to match the most similar blurred template for each feature marker;
wherein a PSF map of the projector is generated that assigns a sigma parameter to each feature marker based on its match to a blurred template.

The method may further comprise:
computing a set of blurred templates as templates for estimating the PSF of the image using the exemplar feature;
computing a Tenengrad response for each blurred template for a similarity metric to match the PSF of each feature marker;
wherein a PSF map of the projector is generated that assigns a sigma parameter to each feature marker based on its match to a blurred template.

The sigma parameter may be any one from the group consisting of:

½, 1, 3/2, 2, 5/2, 3, 7/2, 4.

The method may further comprise:
approximating a spatially varying Wiener filter using the PSF map of the projector; and
computing a set of pre-conditioned basis images using the Wiener filter.

The method may further comprise:
computing the value of each pixel for the pre-conditioned image using a bi-linear interpolation of the basis images;
wherein the basis images and weights for the interpolation are selected from the PSF Map.

The method may further comprise:
finding the four closest neighbours in the PSF map to each pixel by performing coordinate scaling;
wherein the interpolation for each pixel enables the pre-conditioned image for projection to be obtained.

The display surface may be non-planar.

In a second aspect, there is provided a system for minimizing image blur when projecting an image onto a display surface using a projector, the system comprising:
an image capture device to capture a test image projected by the projector; and
an image processing module to estimate a spatially varying point-spread-functions (PSF) profile for the test image, and to pre-condition the image using a predetermined pre-processing algorithm based on the estimated PSF profile;
wherein the pre-conditioned image is projected by the projector to minimise image blur.

In a third aspect, there is provided a method for improving perceptual image quality of an image projected onto a display surface by a projector, the method comprising:
computing an image degradation function of the image; and
pre-conditioning the image using a pre-processing algorithm based on the image degradation function;
wherein the pre-conditioned image is projected by the projector to improve the perceptual image quality.

The image degradation function may be variable depending on the image.

The image degradation function may be computed based on theoretical analysis or estimation of a test image projected by the projector.

The theoretical analysis may be based on a measurement of the pose of the projector.

A sensor may directly observe the projected test image to generate observation data, the observation data being used to estimate the image degradation function of the image.

A sensor may generate observation data by estimating the pose of the projector, the observation data being used to estimate the image degradation function of the image.

The sensor may be any one from the group consisting of: camera, tilt-sensor, infra-red sensor, ultra-sonic pulses, and time-of-flight laser.

### BRIEF DESCRIPTION OF THE DRAWINGS

An example of the invention will now be described with reference to the accompanying drawings, in which:

FIG. 1 is a process flow diagram of a method for minimizing image blur in accordance with a preferred embodiment of the present invention;

FIG. 2 is a block diagram of a system for minimizing image blur in accordance with a preferred embodiment of the present invention;

FIG. 3 is a set of two images: the left image is an original image suffering from blurring, and the right image is a pre-conditioned image which is deblurred;

FIG. 4(a) is an image of a projected image of a plurality of feature markers;

FIG. 4(b) is an image of a pre-conditioned image of the feature markers;

FIG. 4(c) is an image of the pre-conditioned image with its intensity normalized;

FIG. 4(d) is an image of the sharpness response for each feature marker;

FIG. 5 is a graph of an estimated PSF map;

FIG. 6 depicts a series of images illustrating piecewise PSF filtering, where the top images are basis images, the bottom left image is a PSF map and the four nearest neighbours to a pixel, the bottom middle images are zoomed in regions of the four basis images, and the bottom right image is the final composited image;

FIG. 7 is a first set of images, the top row of images showing the original image and the original image when projected, the bottom row of images showing the pre-conditioned image and the pre-conditioned image when projected;

FIG. 8 is a second set of images, the top row of images showing the original image and the original image when projected, the bottom row of images showing the pre-conditioned image and the pre-conditioned image when projected; and

FIG. 9 is an inset of a pre-conditioned image together with the original image when projected.

### DETAILED DESCRIPTION OF THE DRAWINGS

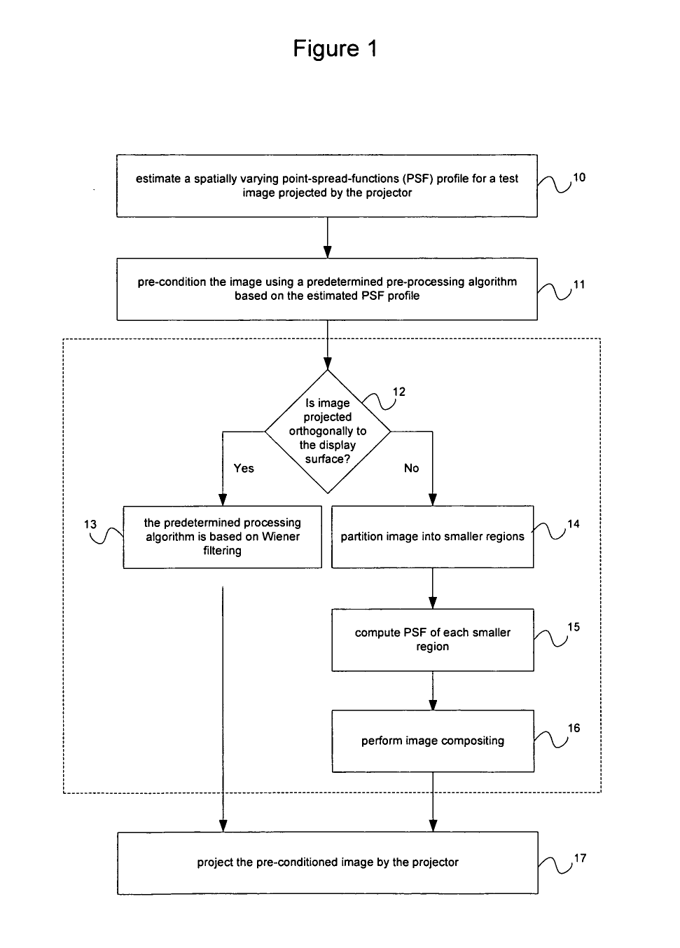

Referring to FIG. 1, a method for minimizing image blur when projecting an image onto a display surface 21 using a projector 22 is provided. The image blur is caused by out-of-focus regions. A spatially varying point-spread-functions (PSF) profile for a test image projected by the projector 22 is estimated 10. The image is pre-conditioned 11 using a predetermined pre-processing algorithm based on the estimated PSF profile. The pre-conditioned image is projected 17 by the projector 22 onto the display surface 21 to minimise image blur.

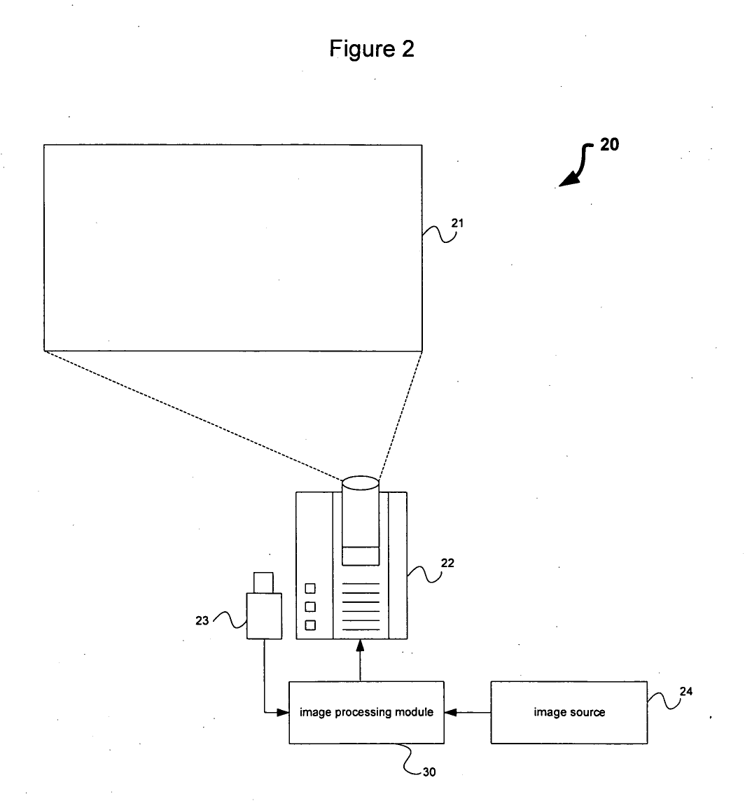

Referring to FIG. 2, an exemplary system 20 for minimizing image blur when projecting an image onto a display surface 21 using a projector 22 is provided. The system 20 comprises: an image capture device 23 and an image processing module 30. The image capture device 23 captures a test image projected by the projector 22. The image processing module 30 estimates a spatially varying point-spread-functions (PSF) profile for the test image, and to pre-condition the image using a predetermined pre-processing algorithm based on the estimated PSF profile. The pre-conditioned image is projected by the projector 22 to minimise image blur. The image is provided via an image source 24, for example, a DVD player or media source. The test image may be provided by the image processing module 30.

### Out-of-Focus Blur

When a projector 22 is out of focus, the light rays emitting from a single projector pixel and collected by the lens system do not converge onto a single point on the display surface 21, but are instead distributed in a small area called the circle-of-confusion. A-blurred image is caused not just by this dispersion of light but also the additive overlap of circles-of-confusion from neighboring pixels. The blur of an image depends on both the size of the circle-of-confusion as well as the distribution profile of light within it. This distribution of light is referred to as the point-spread function (PSF). The PSF in turn depends on a number of factors including aperture size. Projectors and cameras typically do not have pinhole apertures and therefore have a finite depth-of-field. Projectors 22, in particular, are designed to have larger apertures that lead to brighter displays. Larger apertures however suffer from smaller depth-of-fields, e.g. in a thin-lens model the diameter of the circle-of-confusion for an out-of-focus point is directly proportional to aperture size. This is generally not a problem for projection systems as the projector 22 is typically aligned orthogonal to a flat display surface 21, thereby allowing all points on the surface to be simultaneously in focus. However, in applications when the projector 22 is significantly skewed to the display surface 21, or for substantially curved display surfaces 21, there is only a small region on the projected image that is in sharp focus, while the other parts of the projected image suffer varying degrees of out-of-focus blur.

### Uniform Point Spread Functions and Wiener Filtering

Initially, the scenario in which a projector 22 projecting orthogonally to a flat display surface 21 is out of focus is considered. In this scenario, the projected image is uniformly blurred as the PSF (on the display surface 21) is reasonably invariant to the spatial position of the associated pixel in the image.

While the PSF depends on the lens system, it can be reasonably modeled as a 2D circular Gaussian of the form:

$${h}_{σ} = \frac{1}{2 {πσ}^{2}} {e}^{- \frac{{x}^{2} + {y}^{2}}{2 {σ}^{2}}} . \qquad ( 1 )$$

The blurred image created from the overlap of the uniform PSF from different pixels can be modeled as the result of a convolution:

$$\begin{matrix}\begin{matrix}{i}_{B} ( x , y ) = i ( x , y ) \cdot h ( x , y ) \\ = {\sum }_{u} {\sum }_{v} i ( x , y ) h ( u - x , v - y )\end{matrix} & ( 2 )\end{matrix}$$

where i(x, y) and i_{B}(x, y) are the original and blurred images, respectively. Additionally, some additive noise may be present. In image processing, a typical problem is to recover the original but unknown image i(x, y) given only the blurred image i_{B}(x, y). If (2) is valid, the deblurring may also be achieved via convolution with an inverse filter h⁻¹(x,y) such that:

$$\begin{matrix}\begin{matrix}\hat{i} ( x , y ) = {i}_{B} ( x , y ) \cdot {h}^{- 1} ( x , y ) \\ = [ i ( x , y ) \cdot h ( x , y ) ] \cdot {h}^{- 1} ( x , y )\end{matrix} & ( 3 )\end{matrix}$$

where î(x, y) is the estimated deblurred image, assuming that h⁻¹(x, y) exists and the noise is small.

In the present problem, the sequence of operators is different. The goal is to pre-condition the known original image such that when it is projected via the out-of-focus projector 22, the output image appears similar to the original image. Since convolution operators are commutative, (3) may be rewritten as:

î(x, y)=[i(x, y)∘h⁻¹(x, y)]∘h(x, y) (4)

where h(x, y) is the degradation of the original image.

The pre-conditioned image is considered to be the first term of (4), defined as:

ĩ(x, y)=[i(x, y)∘h⁻¹(x, y)] (5)

Thus, the pre-conditioned image ĩ(x, y) after degradation h(x, y) is an approximation of the original image î(x, y). The challenge is to determine the optimal inverse filter h⁻¹(x, y), and this is easily done in the frequency domain, where the blurring process may be dually treated as:

I_{B}(u, v)=I(u, v)H(u, v) (6)

where the I_{B}(•), I(•) and H(•) functions are Fourier transforms of the i_{B}(•), i(•) and h(•) functions respectively. If the PSF is known, Wiener filtering 13 minimizes the mean squared error, for which a simple variation is:

$$\hat{I} ( u , v ) = \frac{{H}^{*} ( u , v ) I ( u , v )}{{\vert H ( u , v ) \vert}^{2} + 1 / SNR} \qquad ( 7 )$$

where Î(•) is the Fourier transform of î(•) , H*(•) is the complex conjugate of H(•), and SNR is the estimated (or apriori) signal-to-noise ratio. Hence the optimal inverse filter for pre-conditioning that is used for uniform PSF is simply given by:

$${h}^{- 1} ( x , y ) = {F}^{- 1} \{ \frac{{H}^{*} ( u , v )}{{\vert H ( u , v ) \vert}^{2} + 1 / SNR} \} \qquad ( 8 )$$

where F⁻¹ is simply the inverse Fourier transform.

Considering (5), (7), and (8), the pre-conditioned image, ĩ(x, y) is obtained by applying the Wiener filtering to the original image, i(x, y), with H(•) such that:

$${F}^{- 1} \{ \hat{I} ( u , v ) \} = {F}^{- 1} \{ \frac{{H}^{*} ( u , v ) I ( u , v )}{{\vert H ( u , v ) \vert}^{2} + 1 / SNR} \} \qquad ( 9 )$$

Assuming that the PSF is known or can be estimated from test images (e.g. fiducial markers), the Wiener filter allows for the pre-conditioning of images for out-of-focus projectors 22 that are projecting orthogonally to the display surface 21.

### Non-Uniform Point-Spread-Functions

When the projector 22 is skewed to the display surface 21 or the display surface 21 is curved, the PSF is not uniform across the projected image and is no longer invariant to the spatial position of the pixel on the display surface 21. One of the significant consequences of this is that the convolution model no longer applies, and Wiener filtering cannot be directly used to pre-condition the image.

To address this problem, a spatially varying PSF profile across the projector is estimated. Ideally, estimating the PSF for each projector pixel is preferred. However, this is difficult. As a compromise, the projected image is partitioned 14 into smaller regions within which a PSF is computed 15. These sub-sampled PSFs are used to compute the pre-conditioned image ĩ(x, y) by compositing 16a series of global PSF corrections described below.

### Framework for Image Pre-conditioning—Projector Blur Estimation

The framework begins by estimating piecewise PSFs in the projector's image. A projector displays an image of equally sized feature markers (crosses) in an off-axis manner onto a flat surface 21. A high-resolution camera 23 captures an image of these projected feature markers. Since the projected feature markers and their observed locations in the camera 23 are known, a 3×3 homography between the camera 23 and projected image is computed to rectify the image captured by the camera 23 to the original image.

Ideally, to derive the PSFs, the original image is compared with the image captured by the camera 23. In practice, however, these two images are sufficiently different due to variety of effects including the camera and projectors imaging systems, display surface response, and properties such as projector's lamp age and color balance settings. Given the difficulty in modeling (and estimating) these effects, operations are performed directly from the rectified camera image. The most in-focus observed feature is located and used as-an exemplar for determining the PSFs of the other features. Since the image captured by the camera 23 is rectified to the original image, the locations of the features are known. The notation i_{f}(x, y) is used to denote the sub-image (bounding box) about a feature marker in the rectified image captured by the camera 23.

Due to lighting variations within the projector 22 and illumination fall off from off-axis projection, intensity responses across the projected image are not uniform. It is necessary to first normalize the features' intensities before finding the exemplar feature. The illuminated display surface 21 exhibits a reasonably uniform response to the projected light from the projector 22. As a result, the nature of the PSFs is exploited to perform the intensity normalization. For display surfaces 21 with non-uniform responses, more sophisticated illumination correction approaches can be used.

The Gaussian PSF used in the blur model sums to unity and therefore does not change the overall energy of the original signal, i.e., it does not change the DC component of the original I(u, v). In other words:

I_{B}(0,0)=I(0,0)H(0,0)=I(0,0),

where the index I(0,0) represents the DC component of each I,I_{B}, and H functions in the Fourier domain. By finding the brightest feature marker,

$${i}_{max} = max {\sum }_{x} {\sum }_{y} {i}_{{f}_{j}} ( x , y ) ,$$

all other feature markers, i_{f}_{₁}(x, y) can be normalized as:

$${i}_{{f}_{j}} ( x , y ) = {F}^{- 1} \{ {I}_{N} ( u , v ) \} \\ where \\ {I}_{N} ( u , v ) = \{ \begin{matrix}{I}_{max} ( 0 , 0 ) & if u = v = 0 \\ {I}_{{f}_{j}} ( u , v ) & otherwise\end{matrix} \qquad ( 10 )$$

From (10), all features are now transformed to have the same DC component as the brightest feature. After normalization, the sharpest feature in the image is found by computing a sharpness response in a block-wise fashion about each feature marker, i_{f}_{ᵢ}(x, y), using the Tenengrad operator as follows:

$${T}_{j} = \frac{1}{n} \sum {s}_{x}^{2} + {s}_{y}^{2} \qquad ( 11 )$$

where, Tⱼ is the sharpness response for a feature marker i_{f}_{ⱼ}(x, y), sₓ and s_{y} are a 5×5 horizontal and vertical Sobel filter responses applied in the spatial domain over all n pixels composing the feature marker i_{f}_{ⱼ}(x, y).

Referring to FIG. 4, steps to find the exemplar feature are illustrated. FIG. 4(a) shows the original image captured by the camera 23. This image is rectified to the projected image depicted in FIG. 4(b), and then normalized as depicted in FIG. 4(c). Sharpness responses computed using (11) are obtained for each block as depicted in FIG. 4(d). The exemplar feature, iₑ(x, y) is the feature corresponding to max(Tⱼ).

### PSF Map Recovery

Given the exemplar template, iₑ(x, y), a set of k blurred templates with increasing σₖ is computed, such that:

i_{e(σ}_{ₖ}₎(x, y)=iₑ(x, y)⊚h_{σ}_{ₖ}(x, y)

where h_{σ}_{ₖ}(x, y) represents the Gaussian PSF described in (1) with parameter σₖ. Typical values of σₖ=½,1, 3/2,2, . . . ,4. These blurred templates i_{e(σ}_{ₖ}₎(x, y) serve as templates for estimating the PSFs across the projected image. Cross correlation can be applied for each projected feature marker i_{f}_{ᵢ}(x, y) against all blurred templates, i_{e(σ)}_{ₖ}₎(x, y), to find most similar blurred template i_{e(σ}_{ₖ}₎(t )(x, y) for each feature. Alternatively, the Tenengrad response is computed for each blurred template i_{e(σ}_{ₖ}₎(x, y) which is used as a similarity metric for matching PSFs, since the Tenengrad responses, Tⱼ for each feature marker i_{f}_{ⱼ}(x, y) are already available from the exemplar search.

The final result is a PSF map, Map_{σ}(u, v) that assigns the appropriate σₖ to each feature marker i_{f}_{ⱼ}(x, y) based on the template matching. To represent the index of the sub-sampled feature, (u, v) is used. For simplicity in notation the variables (u, v) are re-used and should not be confused for the indices used for Fourier functions, e.g. F(u, v). The σₖ associated with each Map_{σ}(u, v) corresponds to the PSF h_{σ}_{ₖ}(x, y) which best approximates the blurring in that region. FIG. 5 shows the resulting Map_{σ}(u, v). The shape of this map appears as the inverse of the Tenengrad responses.

### Computing the Pre-Conditioned Image—Basis Images via Wiener Filtering

As mentioned under the heading Non-Uniform PSFs, because the PSFs are varying spatially within the image, Wiener filtering cannot be applied in a global manner to derive the pre-conditioned image ĩ(x, y). As a compromise, a spatially varying Wiener filter is approximated given the projector blur profile Map_{σ}(u, v).

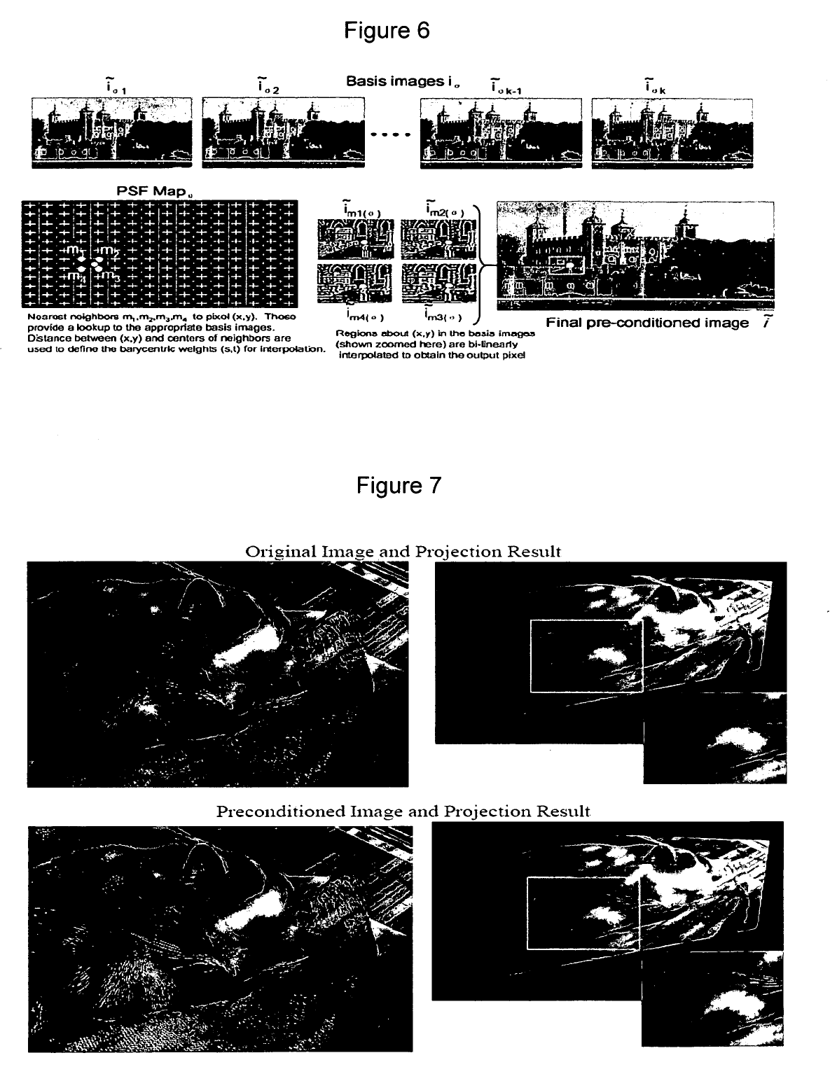

The Map_{σ}(u,v) has k distinct PSFs defined as h_{σ}_{ₖ}(x,y). Using these PSFs h_{σ}_{ₖ}(x,y), a set of pre-conditioned basis images, ĩ_{σ}_{ₖ}(x, y) is computed using Wiener filtering as described in (9), where the filter H for (9) is F⁻¹{h_{σ}_{ₖ}(x, y)}. FIG. 6 (top) shows an example of these basis images.

### Image Compositing

To perform image compositing 16, for a given pixel in the pre-conditioned image, ĩ(x, y), its value is computed using a bi-linear interpolation of the basis images ĩ(x, y). The appropriate basis images and weights for the interpolation are determined from the PSF Map_{σ}(u,v). Performing the appropriate coordinate scaling, the four closest neighbors in the PSF Map_{σ}(u, v) to pixel (x, y) are found. These four neighbors are denoted as m₁,m₂,m₃,m₄ and are ordered in a clockwise fashion about (x, y). Letting m(σ) refer to the m's corresponding σ value, the interpolation is written as:

$$\begin{matrix}\begin{matrix}\tilde{i} ( x , y ) = ( 1 - t ) ( 1 - s ) {\tilde{i}}_{{m}_{1} ( σ )} ( x , y ) + t ( 1 - s ) {\tilde{i}}_{{m}_{2} ( σ )} ( x , y ) + \\ ts {\tilde{i}}_{{m}_{3} ( σ )} ( x , y ) + t ( 1 - s ) {\tilde{i}}_{{m}_{4} ( σ )} ( x , y )\end{matrix} & ( 12 )\end{matrix}$$

where s, 1−s, t, 1−t are the appropriate barycentric coefficients, (s, t ε[0 . . . 1]), in the horizontal and vertical directions between the (x, y) location and the centers of the features associated with m₁,m₂,m₃,m₄. Performing this interpolation for each pixel enables the pre-conditioned image ĩ(x, y) for projection to be obtained.

### Results

Experiments were performed using a 3MMP8749 portable LCD projector with (1024×768) resolution, an Olympus C760 digital camera with 3.2 Mpixels and 10× optical zoom and an IBM Intellistation M Pro. The algorithms are all implemented in unoptimized Matlab 7.0 code.

In the experiments, a grid of 12×16 crosses (feature markers) is projected as depicted in FIG. 4(a). The feature markers are bound by 64×64 pixels blocks. Eight PSFs are estimated using

$${σ}_{k} = \frac{1}{2} , 1 , \frac{3}{2} , 2 , … , 4.$$

as described under the heading Projector Blur Estimation. When computing the basis images, a SNR of 0.01 is provided in the Wiener filter to estimate noise present in the degradation process.

In the experiments, sample images were selected that are sufficiently in focus to demonstrate that results from the algorithm are not merely attributed to a sharpening of the original image. It is worth nothing that the pre-conditioned images will inherently appear sharper than the original image, however, the original images themselves are sharp.

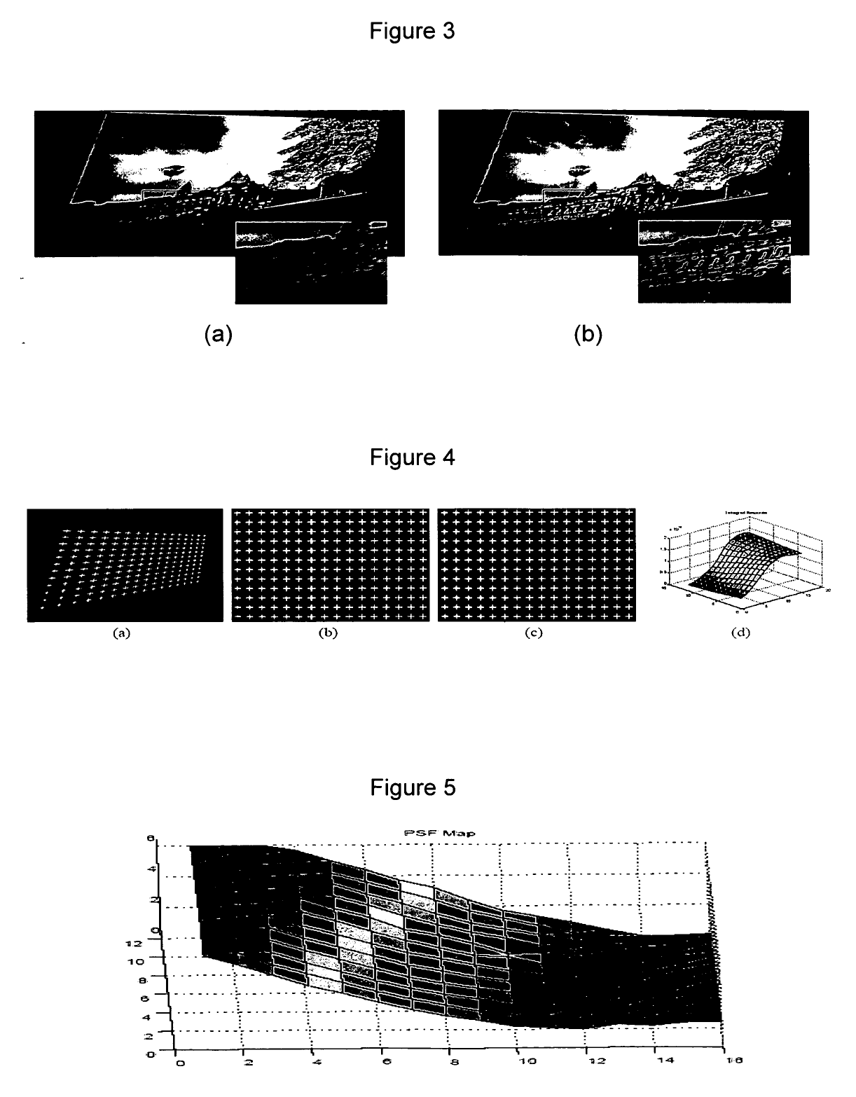

Referring to FIG. 3(a), the original image projected by the projector 22 is illustrated which has blurring due to regions being out-of-focus. FIG. 3(b) illustrates the same image after deblurring pre-conditioning and has been performed, and the pre-conditioned image is projected by the same projector 22.

Referring to FIG. 7, an example of a sleeping cat is illustrated. The top-left image in FIG. 7 shows the original image of a “cat” and the top-right image of FIG. 7 shows its appearance after projection by the projector 22. The out-of-focus blur appearing in the left-bottom corner top-right image. The bottom-left image of FIG. 7 is the corresponding pre-conditioned image ĩ(x, y). Projection of the pre-conditioned image is shown in the bottom-right image of FIG. 7. The texture of the cat's fur appears sharper in the projected pre-conditioned image (zoomed region) than the projected original image.

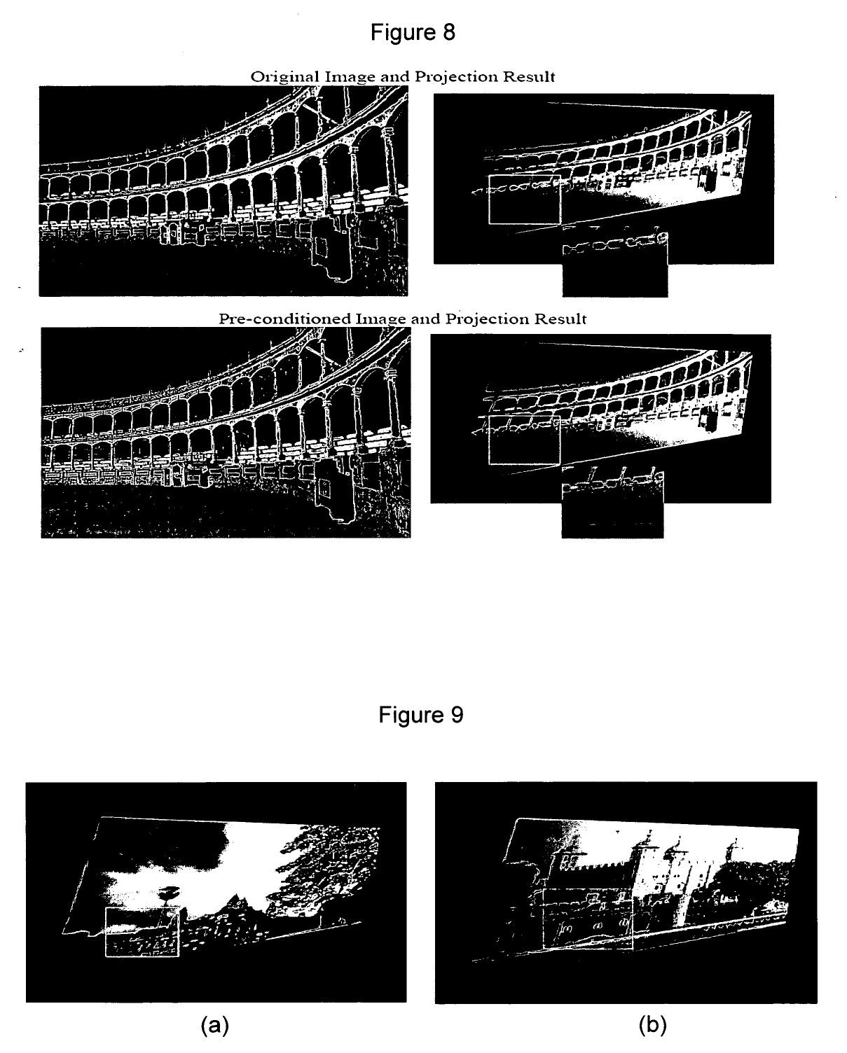

Referring to FIG. 8, an example of an outdoor scene is illustrated. Again, the zoomed region shows the projected pre-conditioned image appearing sharper than the projected original image.

FIG. 9 compares the results as an inset into a projection of the original image. Textures in the blurred regions are better preserved in the projected pre-conditioned image than the projected original image.

Given the nature of the projector-camera system it is difficult to compute quantitative results. However, comparisons may be made. The error between the original image, i, and its blurred countered part, Blur(i), is computed. In this example, the blurring is synthesized using the same image compositing framework described earlier under the heading Image Compositing, except modified to produce basis images that are blurred based on the PSFs. This error is compared to the error between the original, i, and the pre-conditioned image under blur, Blur(ĩ). A 1 to 13% improvement is obtained. The results are shown in the following table:

| FIG. | \|\|I - Blur( )\|\| | \|\|I - Blur(i)\|\| | Improvement |
|---|---|---|---|
| Colosseum (8) | 22204 | 21030 | +5% |
| Cat (7) | 12217 | 12094 | +1% |
| Temple (3 & | 20621 | 18163 | +13% |
| 9 Left) | | | |
| Castle (9 right) | 25806 | 23557 | +9% |

### Display Surface Geometry

In this embodiment, focus has solely been on an off-axis projector 22. However, other embodiments may use any display surface geometry. The only requirement is that the image captured by the camera 23 of the projected feature markers be rectified back to the projector's coordinate frame. Several geometric calibration techniques provide methods for this rectification on non-planar surfaces.

While the effect of projector blur cannot be completely eliminated, it is possible to pre-condition the image to minimise the effect. As with image restoration of blur, the effectiveness of the pre-conditioning approach is related to the estimation of the PSFs and input image itself. In the case of Gaussian PSFs, the Wiener procedure is effectively performing a sharpening. Input images which are already very sharp can result in noticeable ringing in the pre-conditioning process. Likewise, very large PSF (extreme blur) also results in over sharpening. It is possible that the pre-conditioning algorithm may result in pixel values outside the allowed intensity range of the graphics hardware and display capabilities of the projector 22.

Approaches that apply spatial sharpening using an approximation of the inverse filter h⁻¹ as specified in (8) were examined. To obtain acceptable results, very large filters to the point of essentially performing the equivalent of the Wiener filter in the frequency domain using spatial convolution may be used.

The present invention provides a novel technique to pre-condition an image to counter the effects of image blurring due to out-of-focus regions in a projector 22. A camera 23 is used to capture an image of the projected imagery to estimate the spatially varying PSFs across the projected image. A set of basis images are then constructed via Wiener filtering using the estimated PSFs. These basis images are composited together based on projector's estimated blur profile to produce a pre-conditioned image. The results demonstrate that projecting the pre-conditioned image from the projector 22 is successful in minimizing the effects of projector blur.

In another embodiment, there is provided a method for determining image enhancements that improves the perceptual image quality of an image projected by the projector 22 onto a display surface 21. The method comprises: computing an image degradation function of the image to be projected; and pre-conditioning the input image using a pre-processing algorithm based on the estimated degradation function. The pre-conditioned image is projected by the projector 22 to improve the perceptually image quality.

The degradation function could change based on the image to be projected. Thus the method described may dynamically change based on the projected image.

The degradation function may be computed based on theoretical analysis and not purely from an estimation. That is, the degradation function does not necessarily have to be estimated from a test image. For example, if the pose of the projector 22 is known, the degradation that the image would incur may be computed without having to actually estimate it via a sensor 23 or user input.

Alternatively, a sensor 23 is used to estimate the image degradation function. For example, the sensor 23 directly observes the projected imagery, or the sensor performs indirect observation. Indirect observation may include estimating the pose of the projector 22 so that the image degradation function is derived. Sensors 23 include: camera 23, tilt-sensor, infra-red sensor, ultra-sonic pulses, and time-of-flight laser.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A method for minimizing image blur in an image projected onto a display surface by a projector, the image blur being caused by out-of-focus regions, the method comprising:
estimating a spatially varying point-spread-functions (PSF) profile for a test image projected by the projector; and
pre-conditioning the image using a predetermined pre-processing algorithm based on the estimated PSF profile;
wherein the pre-conditioned image is projected by the projector to minimise image blur.

2. The method according to claim 1, wherein the PSF is modeled as a two dimensional circular Gaussian of the form:
$${h}_{σ} = \frac{1}{2 {πσ}^{2}} {e}^{- \frac{{x}^{2} + {y}^{2}}{2 {σ}^{2}}} .$$

3. The method according to claim 1, wherein the predetermined pre-processing algorithm is based on Wiener filtering if the image is projected orthogonally to the display surface and the PSF is known or estimated.

4. The method according to claim 1, wherein the step of estimating a spatially varying PSF profile comprises estimating the PSF for each pixel of the projector.

5. The method according to claim 1, wherein the step of estimating a spatially varying PSF profile comprises:
partitioning the projected image into a plurality of smaller regions; and
computing the PSF for each smaller region.

6. The method according to claim 5, further comprising compositing a series of global PSF corrections using the PSF computed for each smaller region.

7. The method according to claim 1, wherein the test image comprises a plurality of equally sized feature markers in an off-axis manner onto a substantially planar surface.

8. The method according to claim 7, further comprising:
capturing an image of the projected test image using an image capture device; and
computing a 3×3 homography between the image capture device and the projected test image to rectify the captured image to the test image.

9. The method according to claim 8, further comprising computing the PSF by comparing the test image with the captured image.

10. The method according to claim 8, further comprising:
normalizing the intensity of the feature markers by locating a feature marker that is the brightest; and
transforming the other feature markers to have the same DC component as the brightest feature marker.

11. The method according to claim 10, further comprising:
locating a feature marker having the highest sharpness response by computing a sharpness response in a block-wise fashion about each feature marker,
wherein the sharpest feature is an exemplar feature for determining the PSF of the other feature markers.

12. The method according to claim 11, further comprising:
computing a set of blurred templates as templates for estimating the PSF of the image using the exemplar feature;
applying cross correlation for each feature marker against all the blurred templates to match the most similar blurred template for each feature marker;
wherein a PSF map of the projector is generated that assigns a sigma parameter to each feature marker based on its match to a blurred template.

13. The method according to claim 11, further comprising:
computing a set of blurred templates as templates for estimating the PSF of the image using the exemplar feature;
computing a Tenengrad response for each blurred template for a similarity metric to match the PSF of each feature marker;
wherein a PSF map of the projector is generated that assigns a sigma parameter to each feature marker based on its match to a blurred template.

14. The method according to claim 12, wherein the sigma parameter is any one from the group consisting of: ½,1, 3/2,2, 5/2,3, 7/2,4.

15. The method according to claim 13, further comprising:
approximating a spatially varying Wiener filter using the PSF map of the projector; and
computing a set of pre-conditioned basis images using the Wiener filter.

16. The method according to claim 15, further comprising:
computing the value of each pixel for the pre-conditioned image using a bi-linear interpolation of the basis images;
wherein the basis images and weights for the interpolation are selected from the PSF Map.

17. The method according to claim 16, further comprising:
finding the four closest neighbours in the PSF map to each pixel by performing coordinate scaling;
wherein the interpolation for each pixel enables the pre-conditioned image for projection to be obtained.

18. The method according to claim 1, wherein the display surface is non-planar.

19. A system for minimizing image blur when projecting an image onto a display surface using a projector, the system comprising:
an image capture device to capture a test image projected by the projector; and
an image processing module to estimate a spatially varying point-spread-functions (PSF) profile for the test image, and to pre-condition the image using a predetermined pre-processing algorithm based on the estimated PSF profile;
wherein the pre-conditioned image is projected by the projector to minimise image blur.

20. A method for improving perceptual image quality of an image projected onto a display surface by a projector, the method comprising:
computing an image degradation function of the image; and
pre-conditioning the image using a pre-processing algorithm based on the image degradation function;
wherein the pre-conditioned image is projected by the projector to improve the perceptual image quality.

21. The method according to claim 20, wherein the image degradation function is variable depending on the image.

22. The method according to claim 20, wherein the image degradation function is computed based on theoretical analysis or estimation of a test image projected by the projector.

23. The method according to claim 22, wherein the theoretical analysis is based on a measurement of the pose of the projector.

24. The method according to claim 22, wherein a sensor directly observes the projected test image to generate observation data, the observation data being used to estimate the image degradation function of the image.

25. The method according to claim 22, wherein a sensor generates observation data by estimating the pose of the projector, the observation data being used to estimate the image degradation function of the image.

26. The method according to claim 24, wherein the sensor is any one from the group consisting of: camera, tilt-sensor, infra-red sensor, ultra-sonic pulses, and time-of-flight laser.
